(19) United States
(12) Patent Application Publication
(10) Pub. No.: US 2004/0064361 A1
(43) Pub. Date: Apr. 1, 2004

(54) Sale closing software

(75) Inventors: Glen J. Anderson, Sioux City, IA (US); Russell F. McKnight, Sioux City, IA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(73) Assignee: Gateway, Inc.

(21) Appl. No.: 10/261,262

(22) Filed: Sep. 30, 2002

(51) Int. Cl. G06F 17/60

(52) U.S. Cl. 705/14

(57) ABSTRACT

The present invention is a system and method for providing suggested incentives to aid a salesperson in the close of a sale based upon a customer's user history and a business's operating information. The method and system may receive a customer's registration that includes a customer's attributes and may track the shopping patterns of the user. In addition, a business's operating information including real-time sales and inventory records may be monitored and cross-referenced against a customer's attributes and shopping history to provide suggested incentives to aid a salesperson in the close of a sale. The suggested incentives may make it more likely that a customer will close on a sale of a particular product or group of products.

### FIELD OF THE INVENTION

The present invention generally relates to the field of automated sales systems, and more particularly to a system and method for providing enhanced marketing information to aid salespeople in the close of a sale.

### BACKGROUND OF THE INVENTION

As the field of online purchasing has become more popular, consumers are turning to online businesses to make purchases and research products and services. The ability to search and compare products and services from multiple online businesses allows consumers to quickly obtain information regarding products. With online business and research sites, consumers may also have the ability to quickly find a lowest price for products and services. Therefore, businesses engaged in sales of products and services may provide an incentive for each particular customer to make a purchase with their respective business and differentiate their business from competitors. Different customers may desire and react differently to offered incentives, thus it is advantageous to provide an incentive that is desirable for each customer.

When a business is engaged in the selling of multiple products with multiple types of incentives, it is difficult for salespeople of the business to identify and understand all of the current products, features and incentives that are available from the business. Thus, it may be desirable to provide information to salespeople regarding products and incentives available to a particular customer that may be successful in closing a sale to the particular customer. Consequently, a system and method for presenting a list of suggested incentives for a particular customer and providing this information to aid salespeople in the close of a sale is necessary.

### SUMMARY OF THE INVENTION

Accordingly, the present invention is directed to a system and method for monitoring a customer's shopping experiences and a business's operating conditions to generate a list of suggested incentives to aid salespeople in the close of a sale. In an embodiment of the invention, the system of the present invention may receive a registration of customers desiring to browse products through a web site. Included within the registration may be the receipt of a customer's attributes. The method and system of the present invention may monitor the shopping experience of a customer to create a user history which may include purchased products, the incentives offered during purchases, and products browsed.

In conjunction with the monitoring of a customer's shopping experience, a list of operating conditions may be reviewed such as real-time marketing information. Real-time marketing information may include real-time sales information and real-time inventory records. Unadvertised price breaks may be provided to a salesperson upon reaching a certain volume of sales that may then be presented to a potential customer. Additionally, the method and system of the present invention may monitor the incentives being offered by salespeople and adjust a salesperson's commission regarding the sale of particular products to appeal to salespeople. Upon a review of a customer's shopping experience and a list of current operating conditions, a list of suggested incentives may be presented to a salesperson that may be attractive to a customer and is based upon current operating conditions.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts a block diagram representing an embodiment in which a customer may access a system of the present invention;

FIG. 2 is an embodiment of a process for developing a customer's user history in accordance with the present invention is shown;

FIG. 3 is an embodiment of the factors analyzed to generate suggested incentives for a customer in accordance with the present invention;

FIG. 4 is an embodiment of a process for presenting a list of suggested incentives in accordance with the present invention;

FIG. 5 is an alternative embodiment of a process for presenting a list of suggested incentives in accordance with the present invention;

FIG. 6 depicts an embodiment of a presentation of customer information and a list of suggested incentives to aid a salesperson in the close of a sale to the customer; and

FIG. 7 is a block diagram of an information handling system of the present invention.

### DETAILED DESCRIPTION OF THE INVENTION

Reference will now be made in detail to the presently preferred embodiments of the invention, examples of which are illustrated in the accompanying drawings.

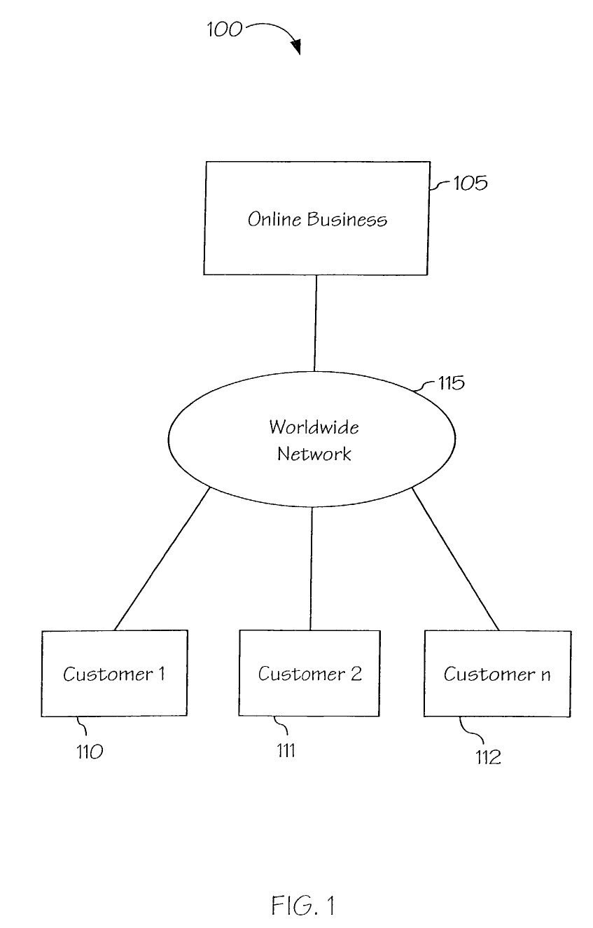

Referring to FIG. 1, a block diagram representing an embodiment in which a customer may access a system 100 of the present invention is shown. An online business 105 of the present invention may be accessed by multiple customers 110-112 through a worldwide network 115. In one embodiment of the invention, a worldwide network may be the Internet including a worldwide collection of networks and gateways that use the TCP/IP suite of protocols to communicate with each other. An online business may be a web site wherein a customer 110-112 may access the web site via a connection to the Internet to purchase products from the business maintaining the web site.

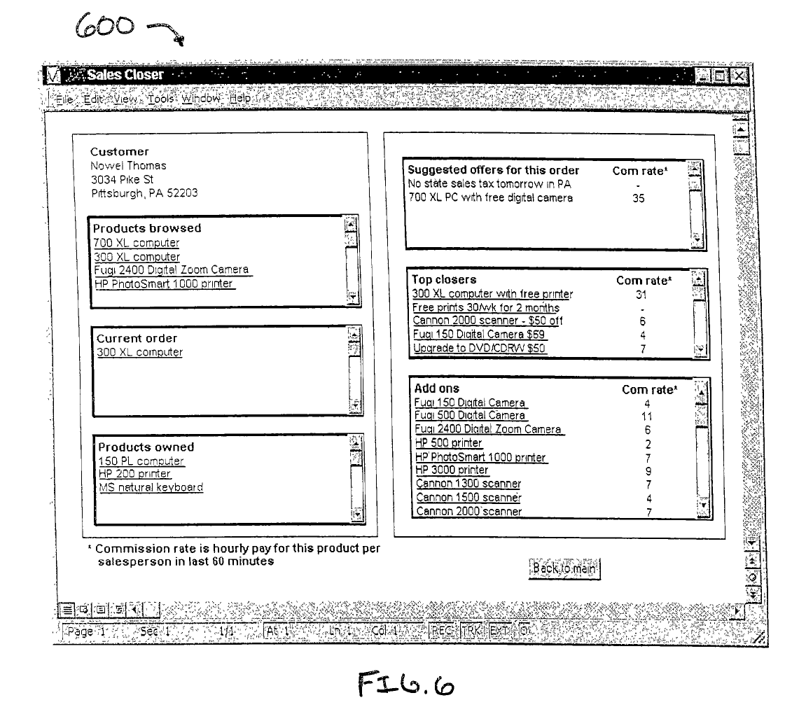

An advantageous aspect of the present invention is the ability to provide suggested incentives for a particular customer to aid a salesperson in the close of a sale. Customers may concurrently speak with a salesperson via a voice connection or through an online chat while visiting a web site, or may speak with a salesperson after visiting the web site. When a salesperson speaks with a particular customer, a presentation (such as shown in FIG. 6) relating to the particular customer may be utilized by the salesperson to assist in closing the sale. In an embodiment of the invention, an online business may execute a computer-implemented service of the present invention that may employ a web site that executes a program of instructions. The execution of a program of instructions may allow a salesperson to review a customer's user history along with current inventory and sales information to assist the salesperson in the close of a sale with a potential customer. It should be understood that computer-implemented service of the present invention is utilized in the sale of goods, however, it is contemplated that the present invention may include products, services, commodities and the like without departing from the scope and spirit of the present invention.

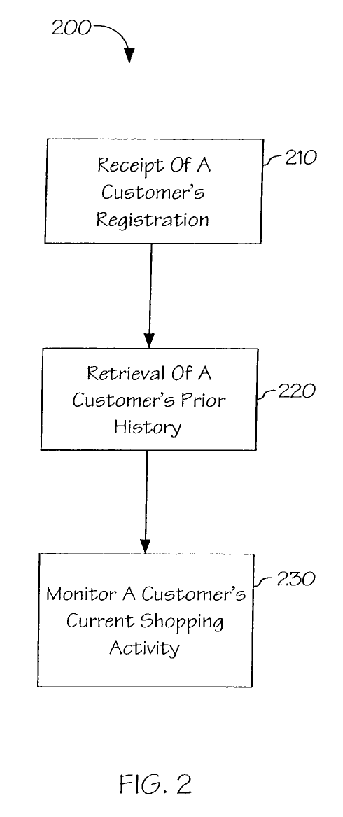

Referring now to FIG. 2, an embodiment of a process 200 for developing a customer's user history in accordance with the present invention is shown. The process may begin upon the receipt of a customer's registration 210. Included within a customer's registration is a customer's attributes. For example, the registration may include a customer's age, sex, marital status, geographical location, income, occupation, number of children and the like. In one embodiment of the invention, registration of a customer may be implemented by querying a customer regarding a customer's attributes when the customer first visits a web site of an online business. Upon later visits to the web site, a customer may simply log on to the web site utilizing a user name and a password, for example. Upon receipt of registration, a customer's prior history may be retrieved 220. The prior history may include information from prior shopping experiences and may include a list of purchases, the incentives offered with each purchase, and a list of products that were browsed but were not purchased. The process may continue by monitoring the shopping experience of a customer during the current shopping visit 230 to create a user history. This may include the analysis of products placed on a purchase order and products that have been browsed but not placed on a current purchase order.

In an alternative embodiment of the process 200 of FIG. 2, the step of retrieving a prior history of a customer's shopping experiences may not be executed. Thus, a customer's user history may be created by monitoring the shopping experience of the customer during a current shopping visit and may not include prior purchases and prior browsed products. It should be understood by those with ordinary skill in the art that various mechanisms exist for monitoring a user's web site viewing, including but not limited to the use of cookies. Therefore, multiple ways of monitoring a user's web site viewing may be implemented in accordance with the present invention without departing from the scope and spirit of the present invention.

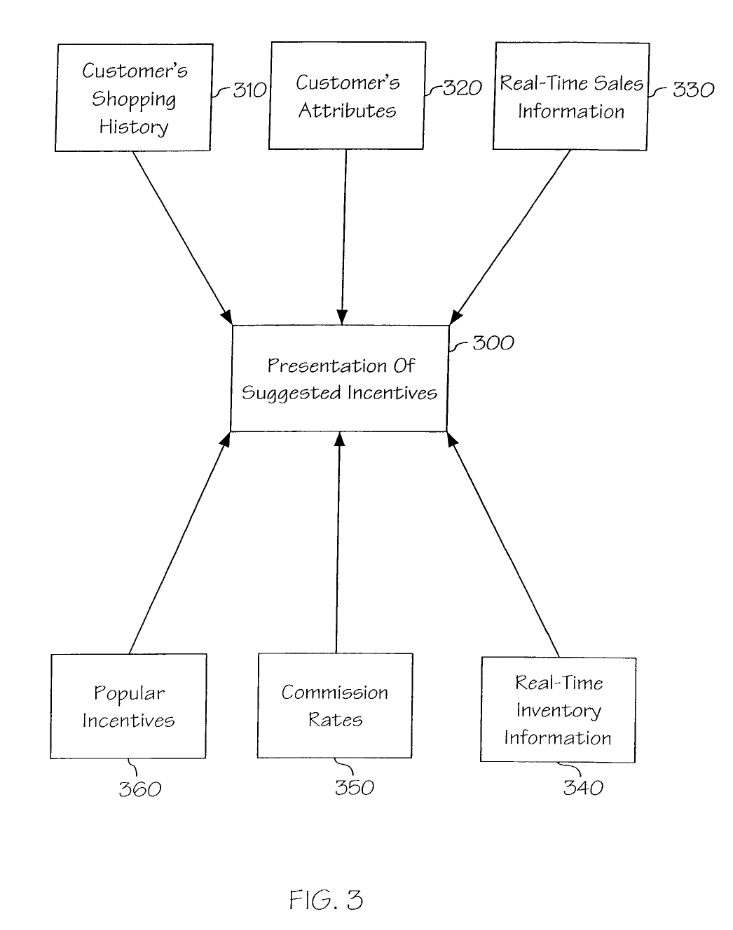

Referring now to FIG. 3, an embodiment of the factors analyzed to generate suggested incentives 300 for a customer in accordance with the present invention is shown. A customer's user history 310 may be analyzed to generate incentives which may be desirable for the particular customer. For example, products which have been browsed by a customer but not purchased nor included within a purchase order may be suggested to a salesperson to help close a sale. Additionally, add-on products and related products for products already purchased and already owned may be suggested to increase the likelihood of closing a sale. Similarly, a customer's attributes 320 may be analyzed and incentives which have been successful with other customers with similar attributes as the current customer may be suggested.

Real-time sales information 330 may be analyzed to suggest popular products which have not been purchased by a customer but are desirable to the general public as evidenced by the number of current sales. Further, real-time sales information may be utilized to provide unadvertised price breaks to a salesperson upon reaching a certain volume of sales that may then be presented to a potential customer. Real-time inventory records 340 may be reviewed to suggest particular products that are currently overstocked. For example, if a company is trying to unload inventory of a particular product, this product may be offered as an incentive to complete a sale of other products. Additionally, current salesperson's commission rates 350 may be monitored to suggest particular products. In an embodiment of the invention, the higher the commission rate for a particular product, the more likely that a salesperson may try to include this incentive in the close of a sale. Therefore, high commission rate products may be suggested as particular incentives. Further, popular incentives 360 may be analyzed in the presentation of a list of suggested incentives. Popular incentives may be products which have been successful in closing sales with other customers.

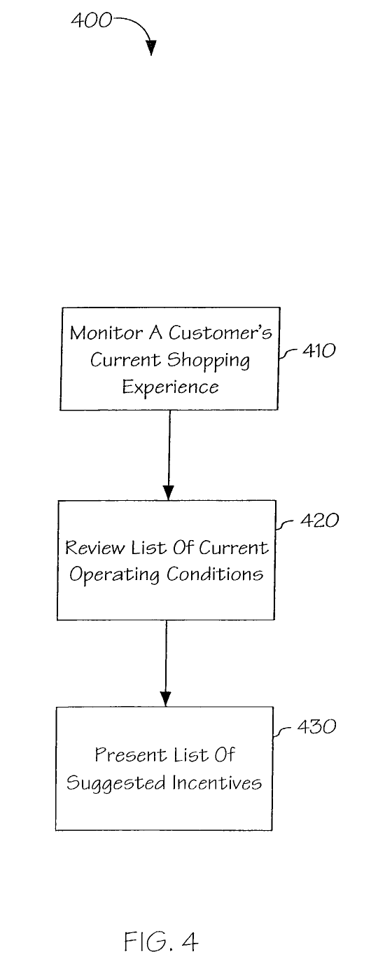

Referring now to FIG. 4, an embodiment of a process 400 for presenting a suggested incentive list to aid a salesperson in the close of a sale is shown. The process may begin upon the monitoring of a customer's shopping experience 410. This may create a user history that may include a list of browsed products and a list of products that have been placed on a purchase order by the customer. A list of current operating conditions may be reviewed 420. The list of current operating conditions may include real-time marketing information such as real-time sales information for each product, real-time inventory information for each product, real-time list of popular incentives which have resulted in successful closes of sale, and real-time commission rate information for each product.

Presentation of a list of suggested incentives 430 may be implemented by cross-referencing the customer's user history and a list of current operating conditions. For example, a list of browsed products may include products A, B, C, D and E. Real-time inventory records may suggest that products A, B, and C are in high supply. Products A and B are popular incentives that have been successful in closing sales. In such an example, products A and B may be suggested incentives. The suggested incentives may be provided to a salesperson to aid in the close of a sale. Thus, during a sales call with the customer, products A and B may be provided as incentives to the customer to close the sale.

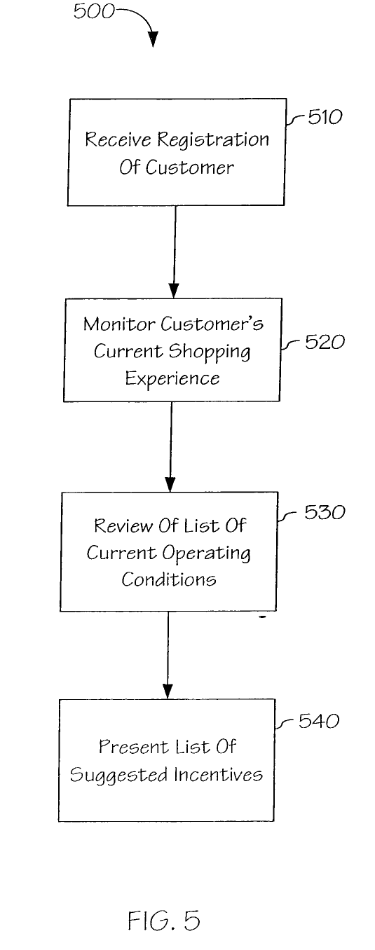

Referring now to FIG. 5, an alternative embodiment of a process 500 for presenting a suggested incentive list to aid a salesperson in the close of a sale is shown. The process may begin upon receipt of a customer's registration 510. The registration may include a list of attributes of the customer and a user history of the customer. The user history may include products purchased in prior shopping visits and prior browsed products. The current shopping experience may be monitored 520. This may include the analysis of products being browsed and products placed into a purchase order by the customer. The current shopping experience may be monitored to supplement the customer's user history. A list of current operating conditions may be reviewed 530.

Similar to the process 400 of FIG. 4, the list of current operating conditions may include real-time marketing information such as real-time sales information for each product, real-time inventory information for each product, real-time list of popular incentives which have resulted in successful closes of sale, and real-time commission rate information for each product. Presentation of a list of suggested incentives 540 may be implemented by cross-referencing the customer's user history, the customer's attributes, and a list of current operating conditions. Thus, the list of suggested incentives may factor in incentives which have been popular for other customers with similar attributes as this particular customer. In one embodiment of the invention, a geographical location attribute may be utilized to present incentives particular to the geographical location of the particular customer. In a specific embodiment of the invention, applicable to processes 400 and 500 of the present invention, a single preferred incentive may be presented to a user during a live sales chat (phone or online chat) to aid the salesperson in attempting to close the sale.

Referring to FIG. 6, an embodiment of a presentation 600 of customer information and a list of suggested incentives to aid a salesperson in the close of a sale is shown. The presentation 600 may be representative of the presentation of a list of suggested incentives as described in processes 400 and 500 of FIGS. 4 and 5. In one embodiment of the invention, presentation 600 may include customer identification, a list of browsed products, the current order, products owned, a list of suggested offers and incentives, and top closers. Top closers may represent incentives that have been popular with other salespersons in closing sales. Further, the commission rate for each incentive is included. In an embodiment of the invention, businesses may utilize the commission rate to appeal to salespeople. The higher the commission rate for a particular product, the more likely that a salesperson may try to include this incentive in the close of a sale.

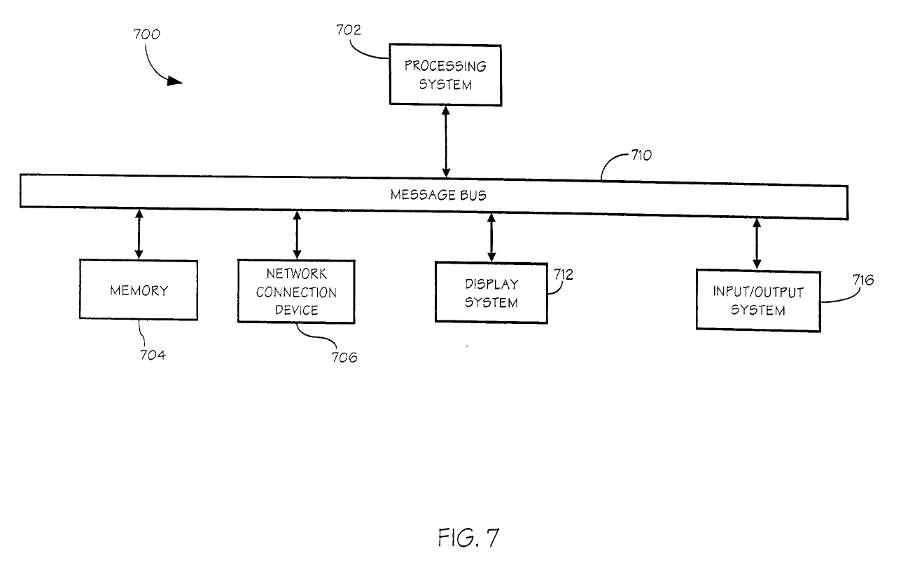

Referring now to FIG. 7, a hardware system in accordance with the present invention is shown. The hardware system shown in FIG. 7 is generally representative of a preferred hardware architecture of an information handling system 700 of the present invention. In one embodiment of the invention, information handling system 700 may be capable of performing processes 400, and 500 of the present invention depicted in FIGS. 4-5. For example, steps of processes 400 and 500 may be implemented as a program of instructions executable by information handling system 700. A controller, for example, a processing system 702, controls the information handling system 700. The processing system 702 includes a central processing unit such as a microprocessor or microcontroller for executing programs, performing data manipulations and controlling the tasks of the information handling system 700. Communication with the processing system 702 may be implemented through a message or system bus 710 for transferring information among the devices of the information handling system 700. The system bus 710 may include a data channel for facilitating information transfer between storage and other peripheral devices of the information handling system 700. The system bus 710 further provides the set of signals required for communication with processing system 702 including a data bus, address bus, and control bus. The system bus 710 may comprise any state of the art bus architecture according to promulgated standards, for example industry standard architecture (ISA), extended industry standard architecture (EISA), Micro Channel Architecture (MCA), peripheral device interconnect (PCI) local bus, standards promulgated by the Institute of Electrical and Electronics Engineers (IEEE) including IEEE 488 general-purpose interface bus (GPIB), IEEE 696/S-600, and so on. Furthermore, the system bus 710 may be compliant with any promulgated industry standard. For example, the system bus 710 may be designed in compliance with any of the following bus architectures: Industry Standard Architecture (ISA), Extended Industry Standard Architecture (EISA), Micro Channel Architecture, Peripheral Device Interconnect (PCI), Universal Serial Bus (USB), Access bus, IEEE P6394, Apple Desktop Bus (ADB), Concentration Highway Interface (CHI), Fire Wire, Geo Port, or Small Computer Systems Interface (SCSI), as examples.

Additionally, the information handling system 700 includes a memory 704. In one embodiment, memory 704 is provided on SIMMs (Single In-line Memory Modules), while in another embodiment, memory 704 is provided on DIMMs (Dual In-line Memory Modules), each of which plugs into suitable sockets provided on a motherboard holding many of the other devices shown in FIG. 7. Memory 704 includes standard DRAM (Dynamic Random-Access Memory), EDO (Extended Data Out) DRAM, SDRAM (Synchronous DRAM), or other suitable memory technology. Memory 704 may also include auxiliary memory to provide storage of instructions and data that are loaded into the memory 704 before execution. Auxiliary memory may include semiconductor based memory such as read-only memory (ROM), programmable read-only memory (PROM) erasable programmable read-only memory (EPROM), electrically erasable read-only memory (EEPROM), or flash memory (block oriented memory similar to EEPROM).

The information handling system 700 may include a network connection device or a network interface 706. The network interface 706 communicates between the information handling system 700 and a remote device, such as external devices, networks, information sources, or host systems that administer a plurality of information appliances. For example, host systems such as a server or information handling system, may run software controlling the information handling system 700, serve as storage for an information handling system 700, or coordinate software running separately on each information handling system 700. The network interface 706 may provide or receive analog, digital, or radio frequency data. The network interface system 706 preferably implements industry promulgated architecture standards, including Recommended Standard 232 (RS-232) promulgated by the Electrical Industries Association, Infrared Data Association (IrDA) standards, Ethernet EEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, 802.66 for wireless networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and Universal Serial Bus (USB), as examples. For example, the network interface system 706 may comprise a network adapter, a serial port, parallel port, printer adapter, modem, universal asynchronous receiver-transmitter (UART) port, etc., or use various wireless technologies or links such as an infrared port, radio-frequency (RF) communications adapter, infrared transducers, or RF modem.

The information handling system 700 may preferably include a display system 712. This may allow for a generation of a display when an information handling system 700 is connected to a display device. The display system 712 may comprise a video display adapter having all of the devices for driving the display device, including video random access memory (VRAM), buffer, and graphics engine as desired. A display device may comprise a liquid-crystal display (LCD), or may comprise alternative display technologies, such as a light-emitting diode (LED) display, gas or plasma display, or employ flat-screen technology.

An information handling system 700 may further include an input/output (I/O) system 716. This may allow for user input via I/O devices when I/O devices are connected to information handling system 700. Input/output system 716 may comprise one or more controllers or adapters for providing interface functions between one or more I/O devices. For example, input/output system 716 may comprise a serial port, parallel port, network adapter, printer adapter, radio-frequency (RF) communications adapter, universal asynchronous receiver-transmitter (UART) port, etc., for interfacing between corresponding I/O devices such as a mouse, joystick, trackball, trackpad, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, touch screen, stylus, electro-acoustic transducer, microphone, speaker, etc. It should be appreciated that modification or reconfiguration of the information handling system 700 of FIG. 7 by a person of ordinary skill in the art would not depart from the scope or the spirit of the present invention.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for providing suggested incentives to aid a salesperson of a business engaged in selling a plurality of goods with regard to a close of a sale, comprising:
(a) monitoring of a shopping experience of a customer to create a user history;
(b) reviewing a list of current operating conditions, said list of current operating conditions including real-time marketing information; and
(c) presenting a list of suggested incentives; wherein said list of suggested incentives is based on said list of current operating conditions cross-referenced with said user history.

2. The method as claimed in claim 1, wherein said user history includes a list of products currently placed in a purchase order.

3. The method as claimed in claim 1, wherein said user history includes a list of products browsed by said customer.

4. The method as claimed in claim 1, wherein said list of operating conditions includes real-time sales information for the plurality of goods.

5. The method as claimed in claim 1, wherein said list of operating conditions includes real-time inventory information for the plurality of goods.

6. The method as claimed in claim 1, wherein said list of operating conditions includes a real-time list of popular incentives which have resulted in sales of the plurality of goods.

7. The method as claimed in claim 1, wherein said list of operating conditions includes real-time commission rate information for the plurality of goods.

8. A method for providing suggested incentives to aid a salesperson of a business engaged in selling a plurality of goods with regard to a close of a sale, comprising:
(a) receiving a registration of a customer, said registration including a list of attributes of said customer;
(b) monitoring of a shopping experience of said customer to create a user history;
(c) reviewing a list of current operating conditions, said list of current operating conditions including real-time marketing information; and
(d) presenting a list of suggested incentives; wherein said list of suggested incentives is based on said list of current operating conditions cross-referenced with said user history and said list of attributes.

9. The method as claimed in claim 8, wherein said user history includes a list of products currently placed in a purchase order.

10. The method as claimed in claim 8, wherein said user history includes a list of products browsed by said customer.

11. The method as claimed in claim 8, wherein said list of operating conditions includes real-time sales information for the plurality of goods.

12. The method as claimed in claim 8, wherein said list of operating conditions includes real-time inventory information for the plurality of goods.

13. The method as claimed in claim 12, wherein an over-stocked product is included on said list of suggested incentives.

14. The method as claimed in claim 8, wherein said list of operating conditions includes a real-time list of popular incentives which have resulted in sales of the plurality of goods.

15. The method as claimed in claim 14, wherein products of said real-time list of popular incentives are included on said list of suggested incentives.

16. The method as claimed in claim 8, wherein said list of operating conditions includes real-time commission rate information for the plurality of goods.

17. The method as claimed in claim 8, wherein said list of attributes includes at least one of age, sex, marital status, number of children, income, occupation, and geographical location.

18. The method as claimed in claim 17, wherein said list of suggested incentives includes incentives which have been included in sales by other customers having said list of attributes as said customer.

19. A system for providing suggested incentives to aid a salesperson of a business engaged in selling of a plurality of goods with regard to a close of a sale, comprising:
(a) means for receiving a registration of a customer upon the commencement of a shopping experience for said customer, said registration including a list of attributes of said customer;
(b) means for monitoring of said shopping experience of said customer to create a user history;
(c) means for reviewing a list of current operating conditions, said list of current operating conditions including real-time marketing information; and
(d) means for presenting a list of suggested incentives; wherein said list of suggested incentives is based on said list of current operating conditions cross-referenced with said user history and said list of attributes.

20. The system as claimed in claim 19, wherein said user history includes a list of products currently placed in a purchase order.

21. The system as claimed in claim 19, wherein said user history includes a list of products browsed by said customer.

22. The system as claimed in claim 19, wherein said list of operating conditions includes real-time sales information for the plurality of goods.

23. The system as claimed in claim 19, wherein said list of operating conditions includes real-time inventory information for the plurality of goods.

24. The system as claimed in claim 23, wherein an over-stocked product is included on said list of suggested incentives.

25. The system as claimed in claim 19, wherein said list of operating conditions includes a real-time list of popular incentives which have resulted in sales of the plurality of goods.

26. The system as claimed in claim 25, wherein products of said real-time list of popular incentives are included on said list of suggested incentives.

27. The system as claimed in claim 19, wherein said list of operating conditions includes real-time commission rate information for the plurality of goods.

28. The system as claimed in claim 19, wherein said list of attributes includes at least one of age, sex, marital status, number of children, income, occupation, and geographical location.

29. The system as claimed in claim 28, wherein said list of suggested incentives includes incentives which have been included in sales by other customers having said list of attributes as said customer.
